(19) United States
(12) Patent Application Publication
(10) Pub. No.: US 2009/0310158 A1
(43) Pub. Date: Dec. 17, 2009

(54) Image Forming Apparatus and Image Forming System

(76) Inventors: Tetsuya Ishikawa, Tokyo (JP); Tsuyoshi Yoneyama, Toyokawa-shi (JP)

Correspondence Address: Cameron Kerrigan;Squire, Sanders & Dempsey L.L.P., Suite 300, One Maritime Plaza, San Francisco, CA, 94111, US

(21) Appl. No.: 12/475,333

(22) Filed: May 29, 2009

(30) Foreign Application Priority Data
Jun. 13, 2008 (JP) JP2008-155812

(51) Int. Cl. H04N 1/60; G06K 15/02; G06F 3/12

(52) U.S. Cl. 358/1.9; 358/1.16; 358/1.15

(57) ABSTRACT

An image forming apparatus, comprises an input section to input identification information of a user; a memory section to memorize an event, time and date of the event, participants of the event and print data of information materials used in the event; a printing section; and a control section to obtain a schedule of a user corresponding to the identification information inputted by the input section during a predetermined period and print data of information materials used in an event included in the schedule from the memory section, and to control the printing section to print the obtained schedule and the information materials based on the obtained print data.

This application is based on Japanese Patent Application No. 2008-155812 filed on Jun. 13, 2008 in Japanese Patent Office, the entire content of which is hereby incorporated by reference.

### BACKGROUND OF THE INVENTION

The present invention relates to an image forming apparatus and an image forming system, In particular, the present invention relates to an image forming apparatus and an image forming system which print based on a user's schedule information material of a conference where the user participates.

In an office, information, such as the time and date, the place, and the participants of events like a conference is registered in a server, and the schedules of office workers are totally administrated based on the registered information. Further, print data (file) of information materials used at conferences are accumulated in the server and administrated totally.

A print administrating system is proposed so as to print information materials of conferences to match schedules without useless based on schedule information administrated in a server and a printing situation of accumulated and administrated information materials (for example, refer the official gazette of Japanese Patent Unexamined Publication No. 7-302181). In this system, at the time of user authentication (individual authentication), a display section is adapted to indicate a screen to ask a user to specify document data to be printed based on schedule information of the individual and print situation information.

In the above-mentioned system, printouts are only information materials. Therefore, although a user obtains the information materials, the user may forget the time and date of a conference and may be absent from or late for the conference. Further, in the case of printing a schedule table on the current day separately from information materials by instructing from a personal computer, the operations for the printing becomes complicated. In addition, if information materials of plural conferences are printed, there is a problem that it may be difficult to discriminate each of information materials prepared for which one of the plural conferences.

The present invention tends to solve the above-mentioned problem, and an object of the present invention is to provide an image forming apparatus and an image forming system both of which enable to grasp a schedule and to obtain information materials related to the schedule.

### SUMMARY OF THE INVENTION

The gist of the present invention for attaining the above object can be attained by the following structures of an image forming apparatus and an image forming system.

An image forming apparatus, comprises:

an input section to input identification information of a user;

a memory section to memorize an event, time and date of the event, participants of the event and print data of information materials used in the event;

a printing section; and

a control section to obtain a schedule of a user corresponding to the identification information inputted by the input section during a predetermined period and print data of information materials used in an event included in the schedule from the memory section, and to control the printing section to print the obtained schedule and the information materials based on the obtained print data.

An image forming apparatus, comprises:

an input section to input identification information of a user;

a communicating section;

a printing section; and

a control section to obtain a schedule of a user corresponding to the identification information inputted by the input section during a predetermined period and attribution information of information materials used in an event included in the schedule from a predetermined schedule administrating server through the communicating section, to further obtain print data of the information materials designated by the obtained attribution information from a predetermined print data administrating server through the communicating section, and to control the printing section to print the obtained schedule and the information materials based on the obtained print data

An image forming system, comprises:

an image forming apparatus;

a schedule administrating server; and

a print data administrating server; wherein the image forming apparatus, the schedule administrating server and the print data administrating server are connected to each other to enable communication to each other;

wherein the schedule administrating server correlate an event with time and date of the event, participants of the event and attribution information of information materials used in the event, and memorizes the event together with the correlated data of the time and date, the participants and the attribution information of information materials; the print data administrating server memorizes print data of the information materials; and the image forming apparatus comprises an input section to input identification information of a user, a printing section and a control section; and

wherein the control section obtains a schedule of a user corresponding to the identification information inputted by the input section during a predetermined period and attribution information of information materials used in an event included in the schedule from the schedule administrating server, further obtains print data of the information materials designated by the attribution information from the print data administrating server, and controls the printing section to print the obtained schedule and the information materials based on the obtained print data.

### BRIEF DESCRIPTION OF THE DRAWINGS

FIG. 1 is an explanatory diagram showing a system configuration of an image forming system related to one embodiment of the present invention.

FIG. 2 is a block diagram showing an outline structure of a composite machine.

FIG. 3 is a block diagram showing an outline structure of a schedule administrating server.

FIG. 4 is an explanatory diagram showing a data administrating structure (an event as a unit) regarding a file of event and information materials.

FIG. 5 is an explanatory diagram showing a data administrating structure (a user as a unit) regarding a file of event and information materials.

FIG. 6 is a flow chart showing operations which a composite machine of an image forming system conducts with regard to printing of a schedule table.

FIG. 7 is an explanatory diagram showing various printing modes of a schedule table and information materials.

FIG. 8 is a front view showing an example of a printed schedule table.

FIG. 9 is a front view showing another example of a printed schedule table.

FIG. 10 is a front view showing an example of a printed cover sheet.

FIG. 11 is a flow chart showing operations which a composite machine of an image forming system conducts with regard to printing of a schedule table and operations in the case of asking a user about printing for information materials.

FIG. 12 is an explanatory diagram showing an example of an information material selecting screen (non-selected state).

FIG. 13 is an explanatory diagram showing an example of an information material selecting screen (all selected state).

FIG. 14 is an explanatory diagram showing an example of an information material selecting screen (individual selected state).

FIG. 15 is an explanatory diagram showing an example of an information material selecting screen which indicates discriminatively information materials to be reprinted.

FIG. 16 is an explanatory diagram showing an example of an information material selecting screen on the condition that information materials except reprinting are selected by all selection.

### DETAILED DESCRIPTION OF THE PREFERRED EMBODIMENT

Hereafter, an embodiment of the present invention will be described with reference to drawings. Here, the present invention is not limited to the embodiment.

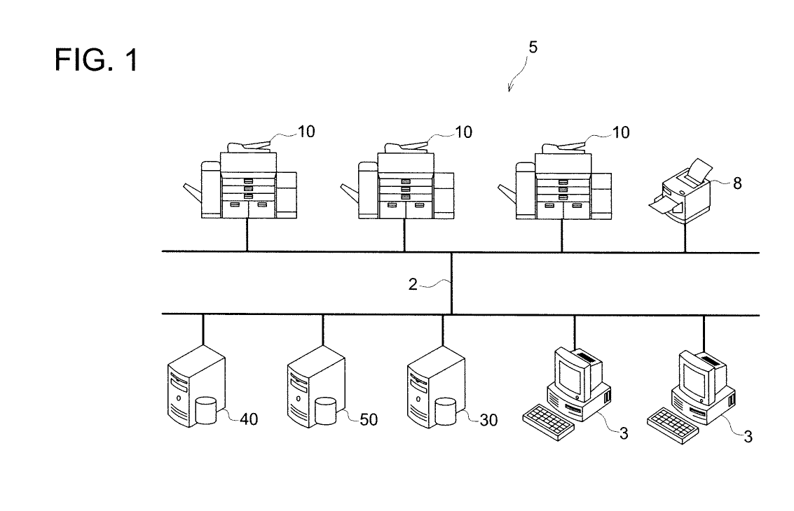

FIG. 1 shows an example of a system configuration of an image forming system 5 according to one embodiment of the present invention. The image forming system 5 is constituted such that a client terminal device 3 comprising a composite machine 10, a printer 8, a schedule administrating server 30, a file administrating server 40, a user authenticating server 50, a personal computer, and the like is connected to a networks 2, such as LAN (Local Area Network).

The composite machine 10 is equipped with a copy function which reads images of document sheets optically and prints its duplicate image on a recording sheet; a scanning function which makes image data of the read document sheets into a file and saves the file or transmits the file to the client terminal device 3 and the like; a printer function which prints image obtained by rasterizing print data received from the client terminal device 3 onto a recording sheet and outputs the image; and a facsimile function which transmits and receives image data.

The schedule administrating server 30 achieves a function to administrate event information, such as a conference. In detail, the schedule administrating server 30 correlates the time and date of an event, the place of the event, the participants in the event (including a organizer), the attribution information of information material relevant to the event and the like to each other, and memorizes and administrates them.

The file administrating server 40 achieves a function which memorizes and administrates the print data (a file being the electronic data of information materials) of information materials used at a conference.

The user authenticating server 50 achieves a function which has memorized authentication information for authenticating a user for every user and specifies and authenticates a user by comparing the inputted user's identification information or authentication information with the memorized authentication information.

When user information, such as user's identification information and authentication information, is inputted from an operating section of the composite machine 10, the client terminal device 3, and the like, a user authentication is performed by the user authenticating server 50 based on the user information. As a result, when a user is authenticated, the image forming system 5 is equipped with a function which prints a schedule during a predetermined period of the user (hereafter, called an authenticated user or a login user) and information materials used in an event such as a conference included in the schedule (for example, today) and outputs them as a set.

For example, if a user conducts login, the composite machine 10 obtains a schedule of today of the login user and the attribution information of information materials used in an event contained in the schedule from the schedule administrating server 30. Furthermore, the composite machine 10 obtains the print data (file) of the information material indicated by the attribution information of the information material from the file administrating server 40, and prints the information material and a schedule table based on the obtained print data and outputs them in a set.

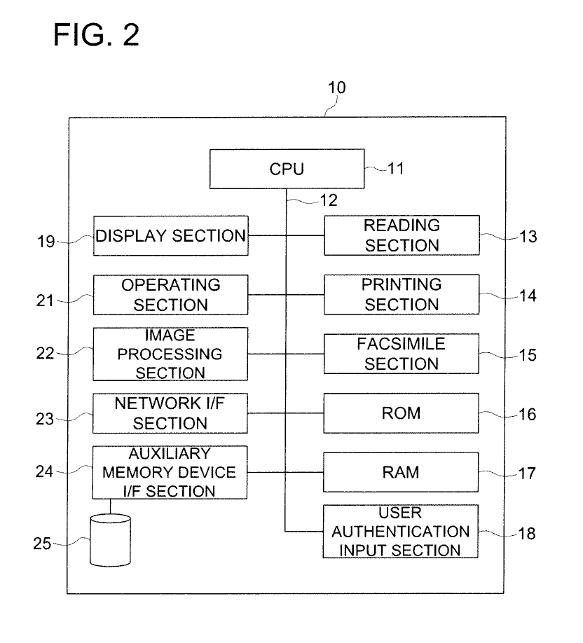

FIG. 2 shows an outline structure of the composite machine 10. The composite machine 10 is constituted such that a reading section 13, a printing section 14, a facsimile section 15, and a ROM (Read Only Memory) 16, a PAM(Random Access Memory) 17, a user authentication input section 18, a display section 19, an operating section 21, an image processing section 22, a network I/F section 23, and an auxiliary storage unit I/F section 24 are connected to a CPU (Central Processing Unit) 11 to control generally actions of the composite machine 10 via a bus 12. Under the auxiliary storage unit I/F section 24, a hard disk device 25 being a large capacity and nonvolatile memory device is connected.

Various kinds of programs are stored in the ROM 16, and when the CPU 11 executes processing in accordance with these programs, each function as the composite machine 10 can be realized. The RAM 17 is a random access memory used as a work memory to store various kinds of data, font data, and the like temporarily and an image memory to stores image data when CPU11 executes a program.

The reading section 13 achieves a function which reads document sheets optically and obtains image data. The reading section 13 is constituted to be equipped with, for example, a light source to irradiate document sheets, a line image sensor to reads document sheets by one line in the width direction in receipt of the reflected light, a shifting device to shift the reading position sequentially one line by one line as a reading unit in the longitudinal direction of document sheets, an optical path consisting of a lens and a mirror to lead the reflected light from document sheets to a line image sensor so as to form an image, and a converter to convert analog picture signals outputted from a line image sensor into digital image data.

The printing section 14 achieves a function which prints images corresponding to image data on a recording sheet. Here, the printing section 14 is constituted as a so-called laser beam printer that comprises a conveying device of a recording sheet, a photoreceptor drum, a charging device, a laser unit, a developing device, a transfer separating device, a cleaning device, and a fixing device, and performs an image formation by an electro-photographic process. The printing section 14 may be a printer with other type printing process.

The printing section 14 is equipped with plural sheet feeding trays and plural output trays, and the printing section 14 is constituted so as to switch a sheet feeding tray to become the feeding source of recording sheets used for printing in accordance with an instruction from the CPU 11 or to switch an output tray used as the delivery destination of recording sheets after printing.

The display section 19 achieves a function to display various kinds of operation screens and setting screens, a guiding screen, and warning, and the display section 19 is constituted by liquid crystal displays (LCD: Liquid Crystal Display) and the like. The operating section 21 is constituted by various control switches, such as a touch panel provided on a screen of a liquid crystal display so as to detect a pushed-down coordinate position, a ten key, and a start button, and the operating section 21 achieves a function to receive various kinds of operations from a user.

The image processing section 22 conducts a rasterizing process to convert print data into image data, a compressing encrypting process to compress and encrypt image data, a restoring decrypting process to decrypt and extend the compressed and encrypted image data, a rotating process of an image and the like. The network I/F section 23 is connected to the networks 2, such as LAN and the Internet and achieves a function to communicate with various apparatus on the network. The facsimile section 15 conducts a communication control for a facsimile transmission or a facsimile reception, calling out (dialing), calling in, a connection with a telephone line, and the like.

In the hard disk drive 25, various files, such as print data, image data and the like are stored. Further, various set-up contents to be memorized in a nonvolatile manner are memorized. The auxiliary storage unit I/F section 24 controls reading writing of data for the hard disk drive 25.

The user authentication input section 18 achieves a function to input information required in order to authenticate users, such as biometric authentication information, a password, and a user ID. The user authentication input section 18 is constituted by input units separately provided in the composite machine 10, such as a biometric authentication unit (a fingerprint authentication, a vein authentication, and the like) and a card reader (may be a contact type or a non-contact type) to read a card (with IC chip) owned by a user. Here, the user authentication input section 18 may be constituted such that the input of user ID, a password, and the like is received from the operating section 21 and the operating section 21 is used as the user authorization input section 18.

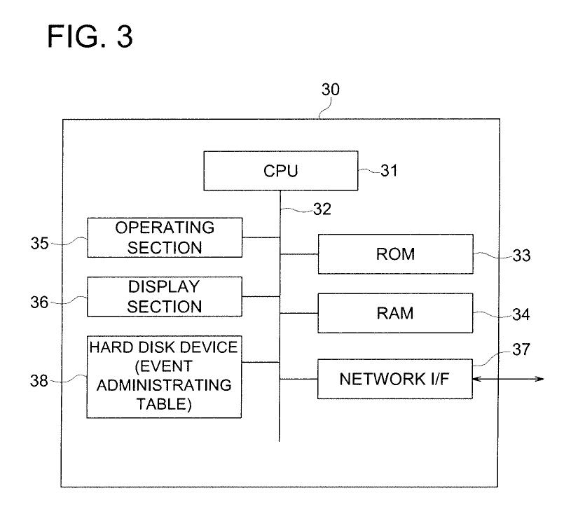

FIG. 3 shows an outline structure of the schedule administrating server 30. The schedule administrating server 30 is constituted such that a ROM 33, a RAM 34, an operating section 35, a display device 36, a network I/F37, a hard disk drive 38 and the like are connected through a bus 32 to CPU31 to control operations of the schedule administrating server 30.

In the ROM 33, programs executed by the CPU 31 are stored. The RAM 34 is used as a work memory and the like. The operating section 35 is constituted by a keyboard, a mouse (pointing device), and the like, and the operating section 35 receives input of a schedule and various kinds of setup operations from an administrator and the like. The display device 36 is constituted by liquid crystal displays and the like, and the display device 36 achieves a function to display various kinds of screens, such as an operating screen and a setting screen. The network I/F 37 achieves a function to enable transmission and reception various kinds of data through the network 2 for other apparatus, such as the composite machine 10, the file administrating server 40, the user authenticating server 50, the printer 8, the client terminal device 3, and the like. In the hard disk drive 38, event information, such as time and date of an event is memorized.

Here, the file administrating server 40 and the user authorization server 50 have the similar hardware structure as that of the schedule administrating server 30, and the software (program) stored in a ROM and the data stored in a hard disk device are different. That is, the file administrating server 40 is provided with programs for administrating file, and in the hard disk device, various files, such as print data, are memorized. The user authenticating server 50 is provided with programs for user authentication, and in the hard disk device, information for user authentication is memorized.

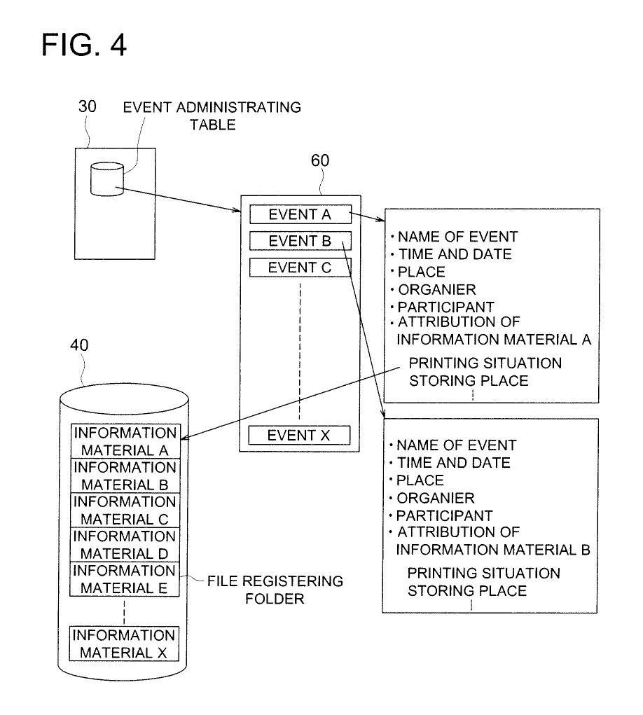

FIG. 4 shows a data administrating structure with regard to an event and a file of information materials. In the schedule administrating server 30, an event administrating table 60 is memorized. In the event administrating table 60, event information including the name of the event, the time and date of the event, the place of the event, the organizer, the participants, and the attribute of information materials used in the event is registered. Into the attribute of information materials, information indicating the storing position of print data (file) of the information materials, information indicating a printing situation, and the like are registered. In addition, the name of information materials, a producer, an access right, and the like may be registered. By the information of the storing position, an event and the file of the information materials used in the event are connected with a string. For example, as the storing position, a full path including the name of a server and the name of a folder is memorized.

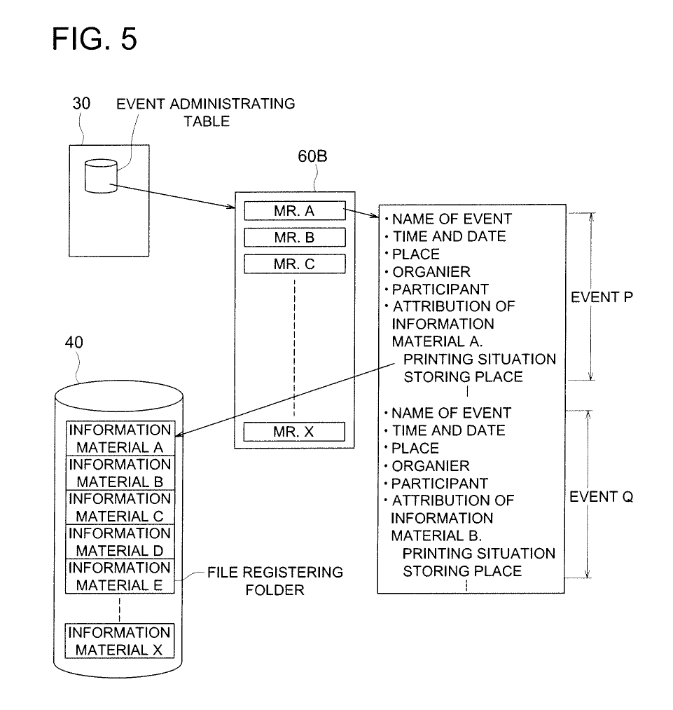

FIG. 5 shows other data administrating structures with regard to files of an event and information materials. In FIG. 5, the schedule administrating server 30 memorizes an event administrating table 60B for each user in which event information of an event for which the user becomes a participant (or a organizer) is registered. In detail, in the event administrating table 60B, an event for which the user becomes a participant (or a organizer) is registered for each user, and the name of the event, the time and date of the event, the place of the event, the organizer, the participants, the attribute of information materials used for the event are registered for each event.

Here, the registration of the event information into the schedule administrating server 30 can be conducted from the operating section 35 of the schedule administrating server 30, and also the event information can be registered from the client terminal device 3, the operating section 21 of the composite machine 10, and the like through the network 2.

Next, the output operation of the schedule table in the image forming system 5 will be explained.

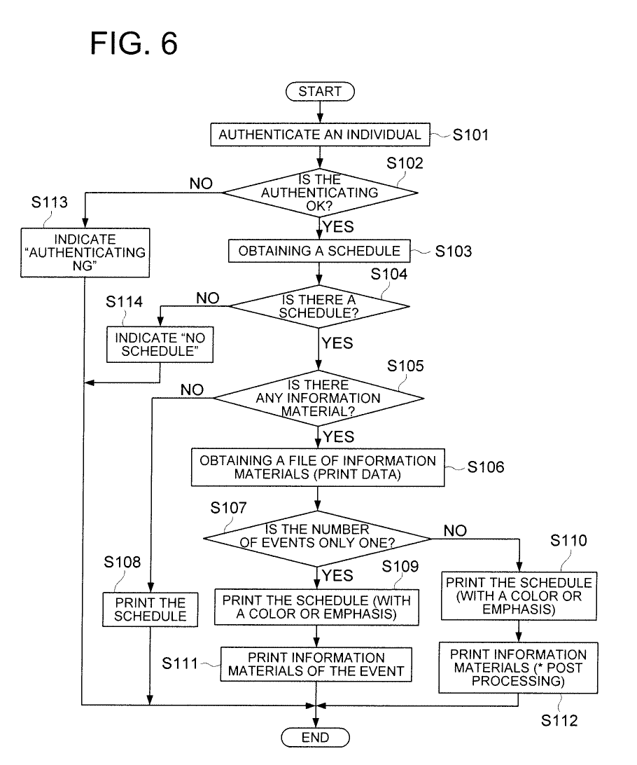

FIG. 6 shows operations of the composite machine 10 in the case of conducting printing automatically for information materials used in an event indicated in a schedule table at the time of printing the schedule table. When the composite machine 10 receives an input of personal authenticating information (a user's authentication information) from the user authentication input section 18 (Step S101), the composite machine 10 transmits the inputted personal authenticating information to the user authenticating server 50, requests a user authentication, and receives the result of the authentication from the user authenticating server 50, whereby the composite machine 10 conducts the user authentication. Here, the composite machine 10 may be structured such that the information for authentication is registered into the interior of the composite machine 10 and the user authorization is conducted within the composite machine 10.

When the user authorization is not succeeded (Step S102; No), that matter is indicate on the display section 19 (Step S113), and the process is ended. On the other hand, in the case that the user authorization is succeeded (Step S102; Yes), the composite machine 10 obtains a schedule with regard to a predetermined period (here, today) of the user for which the user authorization is succeeded, from the schedule administrating server 30(Step S103).

In detail, the composite machine 10 transmits a schedule request including identification information of the user for which the authentication is succeeded, information indicating a predetermined period (this information is not required to be transmitted in the case where the predetermined period is beforehand registered into the schedule administrating server 30, or is fixed), identification information of the composite machine 10 and address information to a schedule administrating server 30. When the schedule administrating server 30 receives the schedule request, the schedule administrating server 30 searches the event administrating table 60 (or the event administrating table 60B) in accordance with the content of the request, extracts corresponding event information, and send a reply with the extracted event information to the apparatus of the transmitting source of the schedule request.

For example, when the schedule administrating server 30 has the event administrating table 60 shown in FIG. 4, the schedule administrating server 30 extracts an event in which the date and time of the event is included in the predetermined period designated by the schedule request and the user designated by the schedule request is included in the participants or the organizer of the event, and sends back information of the extracted event as the corresponding schedule by a reply. When the schedule administrating server 30 has the event administrating table 60B shown in FIG. 5, the schedule administrating server 30 extracts information of an event included in a predetermined period specified by the schedule request among user's event information specified by the schedule request, and sends back this information as a corresponding schedule.

In the case that a reply to the schedule request includes no schedule (with no corresponding event information) (Step S104; No), the composite machine 10 indicates such situation on the display section 19, and ends the process (step S114). In the case that a replay includes a schedule (with a corresponding event information) (Step S104; Yes), the composite machine 10 judges from the information of an event included in the obtained schedule whether or not information materials used in the event exist. Subsequently, in the case that information materials do not exist in any event (Step S105; No), the composite machine 10 prints a schedule table only (Step s108) and ends the process. The schedule table is adapted to be produced in a predetermined format by the CPU based on the schedule (event information) obtained from the schedule administrating server 30, and is printed and outputted by the printing section 14.

In the case that information materials exist in either event included in a schedule (Step S105; Yes), the composite machine 10 obtains a file (print data) of the information materials (Step S106). That is, from the information of a storing position included in the attribute of information materials in event information, the composite machine 10 recognizes the storing position of the information materials and obtains the information materials. Here, the composite machine 10 obtains the information materials from the file administrating server 40.

Next, the composite machine 10 judges whether or not the number of events for which information materials are printed is only single or not among the events included in the schedule (Step S107). In the case that the number of events is only a single event (Step S107; Yes), the composite machine 10 produces a schedule table in which such an event is colored with a specific color or indicated with decorated characters, and the composite machine 10 controls the printing section 14 to print this schedule table (Step S109), further controls the printing section 14 to print information materials of the event (Step S111), and then ends the process.

When there are plural events for which information materials are printed, (Step S107; No), the composite machine 10 produces a schedule table in which these events are colored or indicated with decorated characters so as to be distinguishable from events having no information materials, and the composite machine 10 controls the printing section 14 to print the schedule table (Step S110), further controls the printing section 14 to print information materials of the plural events, and then ends the process. Here, in the case that there are plural events, the composite machine 10 may produce schedule tables colored with respective different colors for the plural events. Further, in the case of printing plural information materials, printing is conducted separately for each of plural events by a post process of switching an output tray.

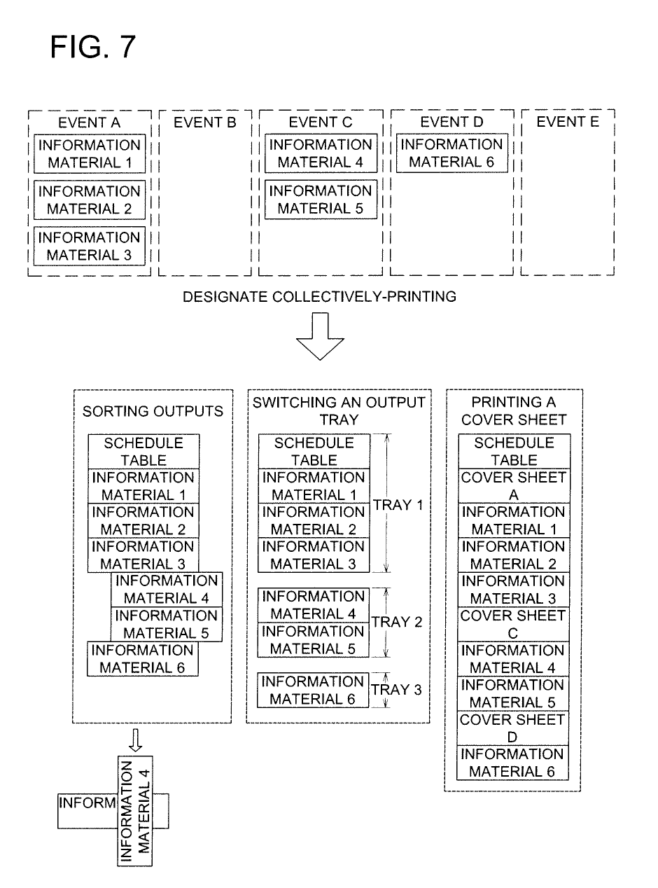

FIG. 7 shows printing examples of a schedule and its information materials. In the examples, the authenticated user is a user X, and the today's events in which the user X participates are events A, B, C, D and E. Among these events, the event having information materials is events A, C and D. The event A has an information material 1, an information material 2, and an information material 3, the event C has an information material 4 and information material 5, and the event D has an information material 6.

As the method of outputting plural information materials separately for each event, there are methods of (1) sorting output, (2) changing over an output tray, and (3) attaching a cover sheet. In the case of sorting an output, recording sheets are discharged in such a way that the orientation of information materials (recording sheets) of an event is switched to an longitudinal direction (the lengthwise direction of the recording sheets corresponds to the conveying direction) and to a transverse direction (the short hand direction of the recording sheets corresponds to the conveying direction) for each event. In the example of FIG. 7, in the case of sorting an output, after a time table has been printed, the information material 1, the information material 2, and the information material 3 relevant to the event A are printed, next, the information material 4 and the information material 5 relevant to the event C are printed with the switched orientation of recording sheets, and thereafter the information material 6 relevant to the event D is printed with the returned orientation of recording sheets.

The switching of the longitudinal direction and the transverse direction is performed as follows. A first sheet feeding tray to store a recording sheet in the longitudinal direction and a second sheet feeding tray to store a recording sheet in the transverse direction are provided. Then, recording sheets to be delivered in the longitudinal direction are fed from a first sheet feeding tray, and recording sheets to be delivered in the transverse direction are fed from a second sheet feeding tray. The image processing section 22 forms an image rotated by 90 degrees on these recording sheets and then these recording sheets are delivered.

In the case of changing over output trays, a schedule table and a information material 1, a information material 2 and a information material 3 related to an event A are delivered to an output tray 1, an information material 4 and an information material 5 related to an event C are delivered to an output tray 2, and an information material 6 related to an event D is delivered to an output tray 3.

In the case of attaching a cover sheet, the schedule table is printed firstly, and then a cover sheet for the event A is printed, and thereafter, the information material 1, the information material 2 and the information material 3 of the event A are printed. Next, a cover sheet for the event B is printed, and then the information material 4 and the information material 5 of the event C are printed. Subsequently, a cover sheet for the event D is printed, and then the information material 6 of the event C is printed.

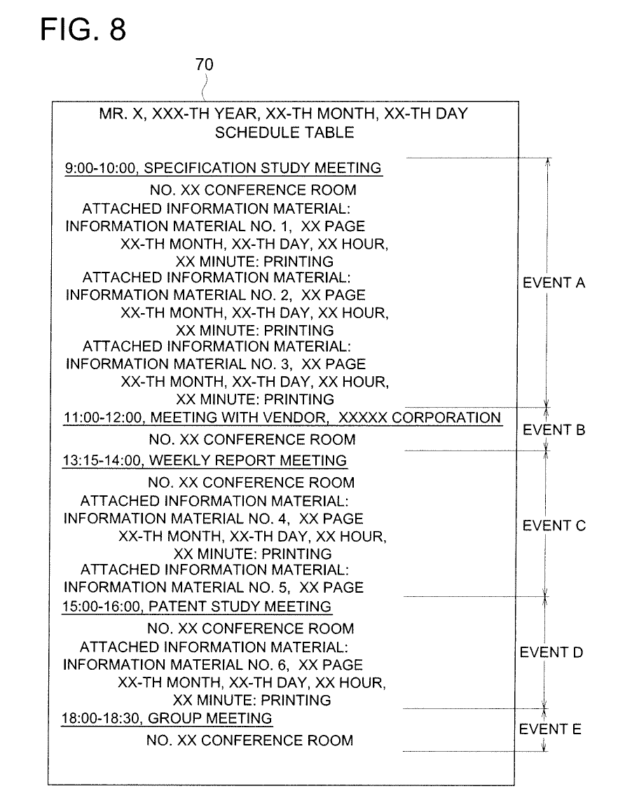

FIG. 8 shows an example of the schedule table printed by the composite machine 10. This example is the schedule table 70 of the case shown in FIG. 7. Since there are information materials to be printed in the events A, C, and D, an underline is applied for the title portion of each of the events A, C, and D in such a way that these events are distinguished from the events B and E in which there are no information materials to be printed. Alternately, these events may be distinguished by a method of applying different colors or background colors on a descriptive portion of events having information materials.

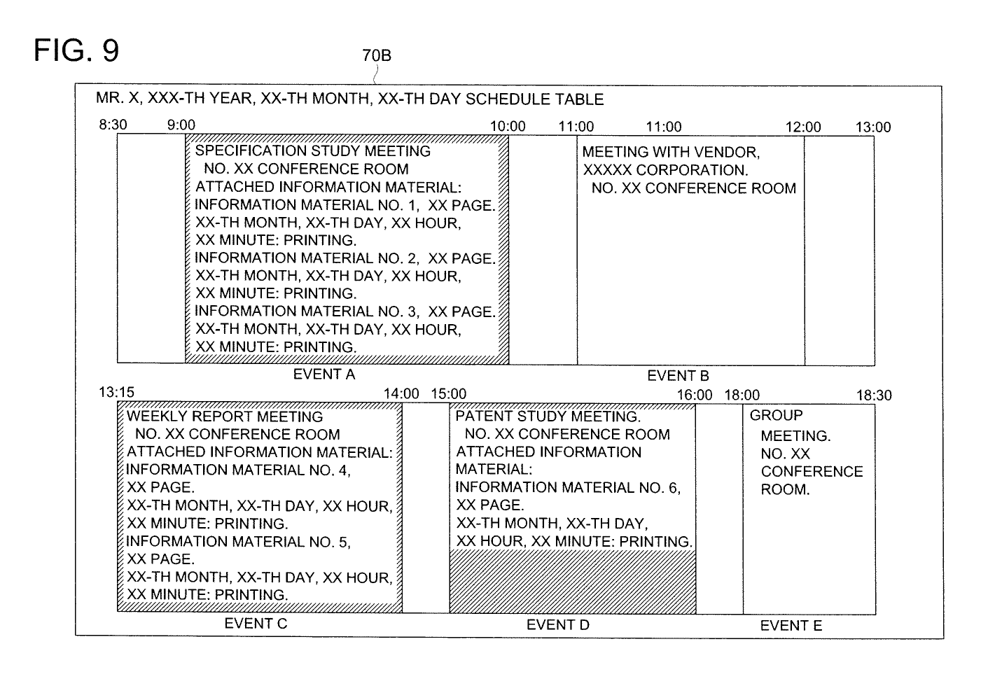

FIG. 9 shows an example of a schedule table 70B which has the same schedule contents as the table in FIG. 8 and, however, is shown in a format (timetable type) different from the table. Oblique lines applied onto a portion (time zone) corresponding to each of the events A, C, and D with respective information materials in such a way that descriptions are made for these events so as be distinguished from the events B and E without information materials. The distinguishable description may be made by a method of applying different character colors to describe the title or contents of an event depending on with or without information materials.

Here, by a method of applying different character colors or different decoration characters among events with information materials to be printed, descriptions may be structured such that the events with information materials are distinguished from each others. For example, printing is made with different colors such as red for the event A, blue for the event C and yellow for the event D. Further, in the case of attaching a cover sheet, if a character color to describe an event on a schedule table and a character color used in a cover sheet related to the event are made to coincide to each other, it becomes easy to distinguish.

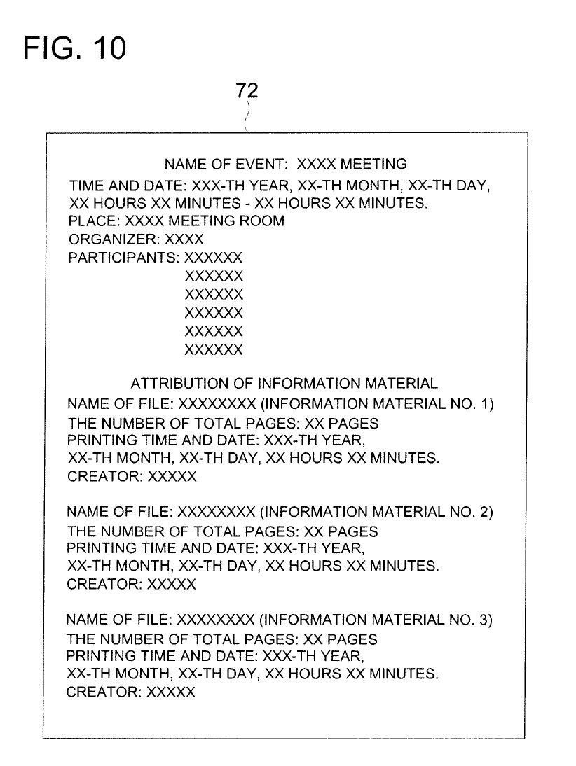

FIG. 10 shows an example of a cover sheet. In a cover sheet 72, the contents of a corresponding event (the name of an event, the time and date of the event, the place of the event, the organizer, the participants, and the like) are described. Further, each of information materials to be printed corresponding to the event, attribution information of each information material (the name of a file, the number of total pages, the time and date of a printing conducted in the past, the name of a preparer of the information material, and the like) are printed.

In this way, when an user authentication is inputted, since a user's schedule and information materials used in events contained in this schedule are printed automatically in one set, the confirmation of a schedule and the procurement of information materials of the schedule can be conducted surely and easily. Therefore, it is possible to support a user such that the user can attend each of events with required information materials without mistaking the time and date and the place.

Next, when printing a schedule table, operations in the case of asking a user whether information materials are to be printed together with the schedule table, will be explained.

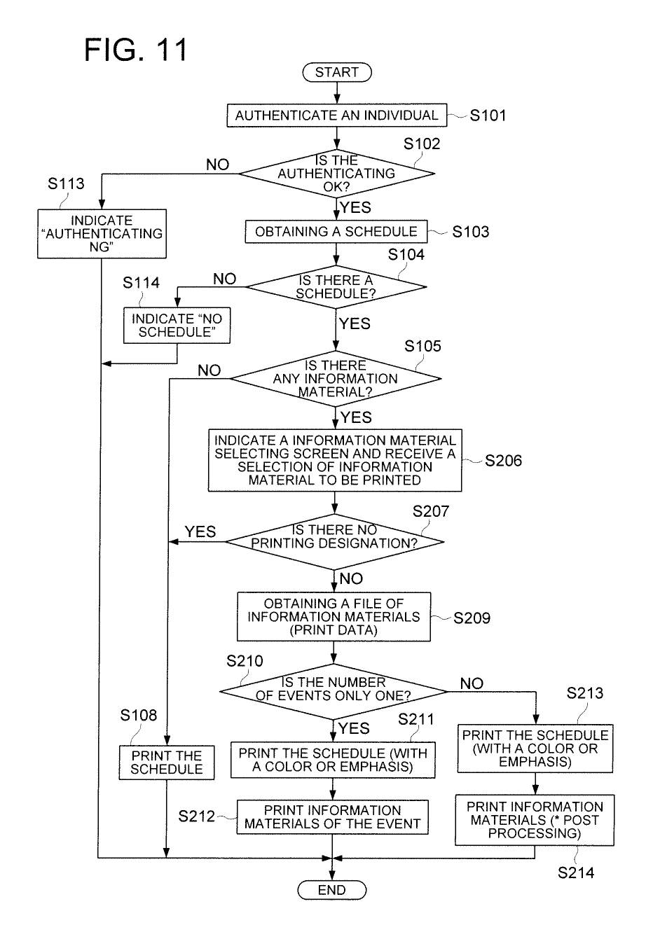

FIG. 11 shows the flow of the above-mentioned operations. Here, a part having the same operation content as that in FIG. 6 is applied with the same step number, and the explanation for them is omitted suitably. When the composite machine 10 receives an input of a personal authenticating information (a user's authentication information) from the user authentication input section 18 (Step S101), the composite machine 10 conducts an authentication for the user. As a result, if the user authentication is not succeeded (Step S102; No), that result is indicated on the display section 19 (Step S113), and the operation is ended.

On the other hand, if the user authentication is succeeded (Step S102; Yes), the composite machine 10 obtains a schedule during a predetermined period (in this case, today) of the user having succeeded in the user authentication from the schedule administrating server 30 (Step S103). At this time, if there is no schedule (with no corresponding event information) (Step S104; No), the result is indicated on the display section 19 (Step S114), the operation is ended. On the other hand, if there is a schedule (with a corresponding event information) (Step S104; Yes), the composite machine 10 judges whether or not there is any information material used in events contained in the obtained schedule. As a result, if there is no information material (Step S105; No), only a schedule table is printed (Step S108), and an operation is ended.

On the other hand, if there are information materials in any one of events contained in the schedule (Step S105; Yes), the composite machine 10 indicates a predetermined data selecting screen for receiving a selecting operation to select information materials to be printed from a user on the display section 19, and receives a selecting operation from a user (Step S206). Here, if the composite machine 10 receives a selecting operation intending not to print any information material from the user (Step S207; Yes), only a schedule table is printed (Step S108), and an operation is ended.

If the composite machine 10 receives a selecting operation intending to print one of information materials, the composite machine 10 obtains a file of the selected information material from the file administrating server 40 (Step S209). Next, the composite machine 10 judges whether or not the number of events with information materials to be printed is only one in the schedule (Step S210). In the case that the number of events is one (Step S210; Yes), the composite machine 10 produces a schedule table in which the event is colored with a specific color or applied with a character decoration, and makes the printing section 14 to print it (Step S211). Furthermore, the composite machine 10 makes the printing section 14 to print the selected information materials (Step S212), and an operation is ended.

In the case that there are plural events with information materials to be printed (Step S210; No), the composite machine 10 produces a schedule table in which the events are colored or applied with a character decoration so as to be distinguished from events having no information material, and makes the printing section 14 to print it (Step S213). Furthermore, the composite machine 10 classifies information materials of the selected events for each event as shown in FIG. 7, and makes the printing section 14 to print the classified information materials (Step S214), and an operation is ended. Here, in the case that there are plural events, the composite machine 10 produces a schedule table with a different color for each of the plural events and prints it.

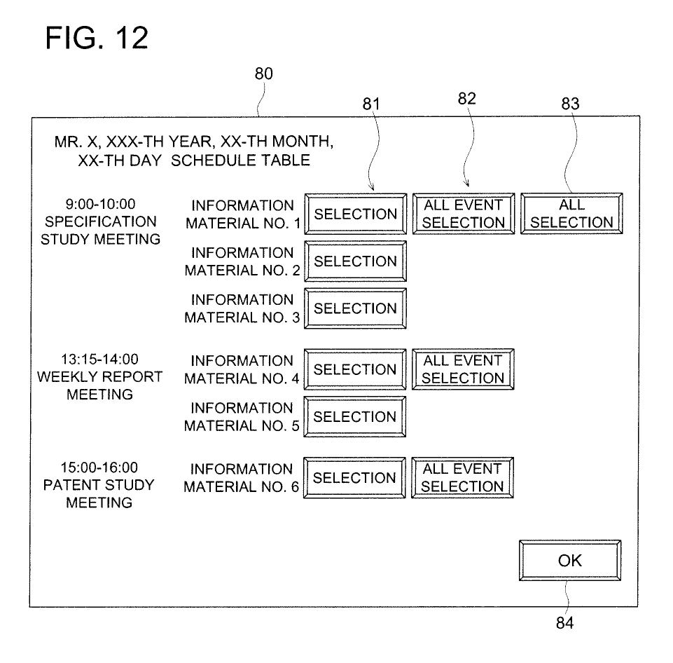

FIG. 12 shows an example of the information material selecting screen 80 displayed at Step S206. On the information material selecting screen 80, the time and date (holding time) of an event, the title of the event, and the name of information materials used in the event are indicated for each of events having information materials. On the right side of the name of each information material, indicated is an individual selecting button 81 for selecting individually whether or not a corresponding information material is to be printed. Further, for each of the events, indicated is an event all selecting button 82 for selecting all information materials used in a corresponding event as a printing object. Furthermore, an all selecting button 83 for selecting all information materials of all events as a printing object collectively and an O.K. button 84 for acknowledging the content of a selection are indicated. In the individual selecting button 81, the event all selecting button 82 and the all selecting button 83, a selected state and a no-selected state are switched over at each time of pushed-down.

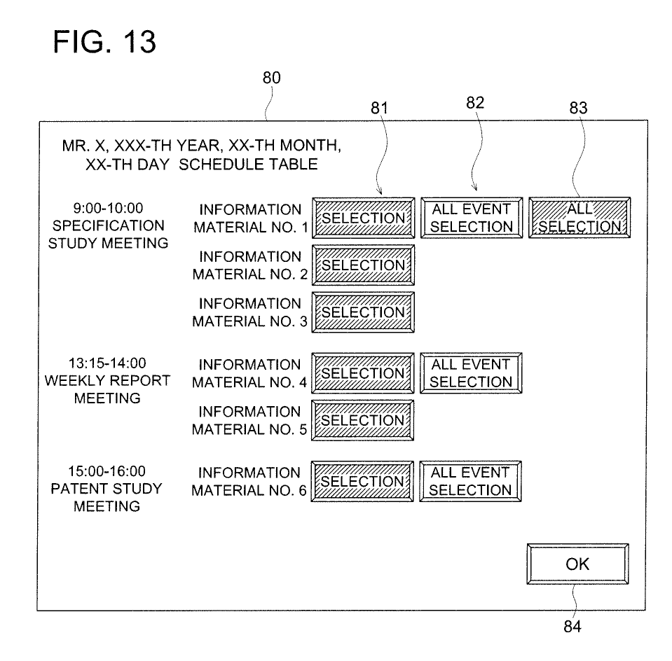

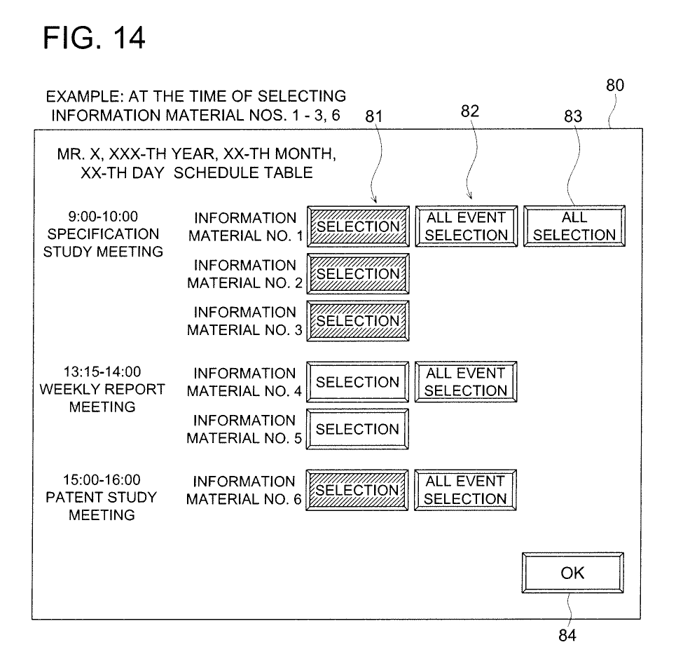

In the information material selecting screen 80 shown in FIG. 12, all information materials are in the non-selected state, and if the O.K. button 84 is pushed down in this state, the information materials are made on the state “no information material to be printed”. FIG. 13 shows the state that the all selecting button 83 is operated. That is, if all selection is made by the all selecting button 83, all the individual selecting buttons 81 are made in the selected state. FIG. 14 shows the information material selecting screen 80 on the condition where the information material 1, the information material 2, the information material 3, and the information material 6 are selected. In each drawing, oblique lines are applied to a button being on the selected state.

In this way, when a schedule is printed, since a user is asked whether information materials used in events contained in the schedule are to be printed, it is possible to prevent printing for information materials which are considered unnecessary by the user.

Next, an explanation will be made about the case that a selection of information materials as a print object is received after a user is notified of information whether information materials have already been printed or has not been printed. As shown in FIG. 4 and FIG. 5, information showing a printing state as an attribute of information materials is registered in the event administrating table 60. This information shows whether or not information materials have been already printed. Since this information is held separately for each user, it is possible to acknowledge for each user whether or not information materials have been already printed in the past. The CPU 11 recognizes based on information on a printing state obtained from the schedule administrating server 30 whether or not an authenticated user has printed information material, and indicates the result of the recognition on an information material selecting screen to notify a user.

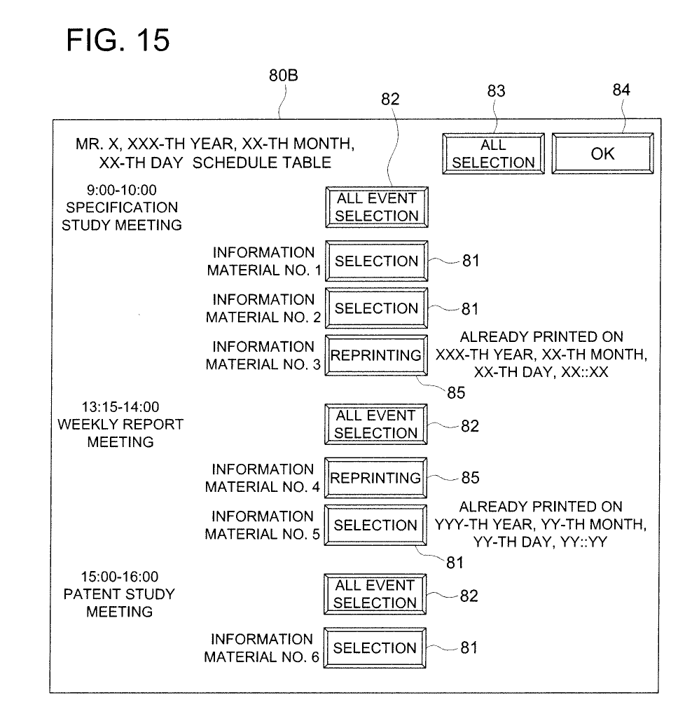

FIG. 15 shows an example of the information material selecting screen 80B to indicate recognizably whether or not each information material has been printed. For the information materials having been already printed, a reprinting button 85 showing that the information material has been printed is indicated in place of the individual selecting button 81. Further, information showing the time and date of the printing is also indicated in the vicinity of the reprinting button 85.

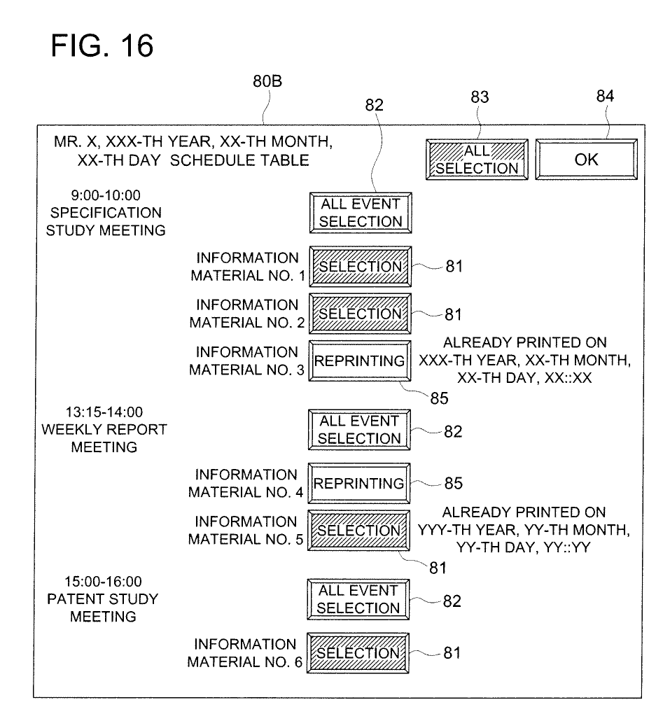

Here, in the case that the event all selecting button 82 or the all selecting button 83 is operated, the information materials having been already printed may be included in a selection object, the information materials having been already printed may be excluded automatically from a selection object. FIG. 16 shows an example of the sate that the information materials having been already printed may be excluded from a selection object in the case that the all selecting button 83 is operated.

In this way, a user is notified of information about whether or not the information material has been printed, or in the case that all of plural information materials are selected collectively by the all selecting button 83, information materials having been already printed are excluded automatically. As a result, it becomes possible to prevent information materials having been already possessed from being reprinted. Here, if the reprinting button 85 is operated, a user can reprint information materials having been already printed. Therefore, it is possible to respond individually a user need.

Here, in the case that a user authentication is succeeded, information material are printed automatically together with a schedule table as shown in FIG. 6, or an information material selecting screen is indicated so as to ask a user as shown in FIG. 11. An operation setup to select either one of above two operations can be registered individually for each user. The content of the operation setup is stored the hard disk device 25 for example. When a user authentication is succeeded, the CPU 11 obtains the content of the operation setup related to the authenticated user from the hard disk device 25, and operates in accordance with the content of the operation setup. For example, it is presumed that the operation setup is set such that an automatic printing operation is set for the user A and an enquiring operation with an information material selecting screen is set for the user B. On the above condition, when the user A is authenticated personally, a schedule table and corresponding information materials of the user A are printed automatically in a set. Further, when the user B is authenticated personally, an information material selecting screen 80 and the like are indicated at the time of printing a schedule table of the user B such that a selecting operation to select information materials as a printing object is received from the user B.

Here, it may be structured that the content of the operation setup is memorized in a nonvolatile memory of the composite machine 10 or correlated with a user ID and registered in the user authenticating server 50. For example, in the latter case, when a user authentication is succeeded, the content of the operation setup correlated with the user is transmitted from the user authenticating server 50 to the composite machine 10. Then, the composite machine 10 executes operations related to the printing of a schedule table and information materials in accordance with the content of the operation setup received from the user authenticating server 50.

As mentioned above, the embodiments of the present invention have been explained with reference to the drawings. Here, concrete structures are not limited to what was shown in the embodiments. That is, modifications and additions within a range not deviating from the gist of the present invention are made, such modifications and additions are included in the present invention.

For example, the schedule administrating server 30 and the file administrating server 40 may be constituted as one server, and the function of the user authenticating server 50 may be further included in the server. Further, in the embodiments, the CPU 11 of the composite machine 10 conducts the function to judge whether or not there are information materials in events included in a schedule and the function to obtain a file related to the information materials. However, such functions may be conducted by another server. For example, in the case that a user authentication is succeeded in a user authenticating server 50, it may be structured that the user authenticating server 50 obtains a today's schedule of the authenticated user from the schedule administrating server 30, further obtains a file of information materials described in the schedule from the file administrating server 40, and transmits the schedule and the file of the corresponding information materials to the composite machine 10. Here, the file of the corresponding information materials may be structured to be directly transmitted from the file administrating server 40 to the composite machine 10.

As described above, in the embodiments, the image forming system 5 were constituted such that the functions of the image forming system 5 were distributed separately to the schedule administrating server 30, the file administrating server 40, the user authenticating server 50, and the composite machine 10. However, the system constitution is not limited to the above. For example, the image forming system 5 may be constituted such that the functions of the image forming system 5 are combined optionally into two or more groups and distributed separately to two or more devices connected to be able to communicate with each other.

Furthermore, the composite machine 10 may be constituted to be provided with all the functions provided in the image forming system 5, and a schedule administration and a printing process equivalent to those in the image forming system 5 are conducted by only the composite machine 10. Namely, the composite machine 10 may be constituted such that event administrating tables 60, files of information materials and data for user authentication are stored in the hard disk device 25 of the composite machine 10, the CPU 11 obtains required information (a schedule and a file) from the hard disk device 25 instead of communicating with the schedule administrating server 30, the file administrating server 40, and the user authenticating server 50, and the composite machine 10 conducts printing a schedule table and information materials.

Furthermore, it is possible to make the authentication operation in the user authentication input section 18 to cooperate with a working hour administrating system such that the schedule administrating server 30 administrates working hour such as attending and leaving of each person. Whereby, in Step 105 in FIG. 6 and FIG. 11, it becomes possible to judge whether or not there are information materials newly registered after “leaving office”. Therefore, the information materials newly registered after “leaving office” is constituted such that only these information materials are printed automatically or an information material selecting screen to make it possible to recognize these information materials separately from others is indicated so as to receive a selection of information materials as a printing object from a user.

In the embodiments, the case where the composite machine 10 conducts printing was exemplified. However, a printer 8 may conduct printing and an input operation (login operation) of a user's authentication information may be performed by the client terminal device 3. For example, when a user conducts log in and is authenticated by the client terminal device 3, it may be constituted that the user's schedule is checked and a schedule and relevant information materials usable in events contained in the schedule are printed automatically in a set by the printer 8 or the composite machine 10. Alternately, it may be constituted that a screen equivalent to the data selecting screen 80 is indicated on a display screen of the client terminal device 3 so as to receive a selecting operation for information materials, and a schedule table and the selected information materials are printed by the printer 8 or the composite machine 10 and are outputted. The processing operations to conduct the above operations may be performed in accordance with a predetermined program by, for example, the client terminal device 3, or by an arbitrary device such as the user authorization server 50 in the image forming systems 5.

Here, the predetermined period is not limited to “today”. For example, in the case that a user authentication is succeeded, it may be constituted that an object period to print a schedule table is asked to a user, or the method to make the predetermined period to what kind of period (for example, today, tomorrow or one week from today) is constituted to be able to be registered in advance (preferably for each user).

In addition, in the case of limiting a user to whom information materials are distributed, the name of each user allowed to receive the distribution of the information materials is registered as the attribute of event information or information materials. In this case, even if information materials are relevant to an event to which an authenticated user participates, if the authenticated user is not a user allowed to receive the distribution of the information materials, the information materials is controlled not to be an printing object for the authenticated user.

As described above, the object of the present invention can be attained by an image forming apparatus and an image forming system with the following preferable structures.
[1] An image forming apparatus is characterized in that the image forming apparatus is equipped with an input section to input user's identification information, a memory section to memorize the time and date of an event, the participants of the event and print data of information materials used in the event by correlating them, a printing section and a control section; the control section obtains a schedule during a predetermined period of a user corresponding to the user's identification information inputted by the input section and print data of information materials used in an event included in the schedule from the memory section, and the control section controls the printing section to print the obtained schedule and the information materials based on the obtained print data.

In the above-mentioned invention, a schedule during a predetermined period of a user (for example, an authenticated user or a login user) corresponding to the inputted user's identification information and print data of information materials used in an event included in this schedule are obtained from the memory section of the image forming apparatus, and the obtained schedule and the information materials based on the print data are printed and outputted as a set.
[2] An image forming apparatus is characterized in that the image forming apparatus is equipped with an input section to input user's identification information, a communicating section, a printing section, and a control section; the control section obtains a schedule during a predetermined period of a user corresponding to the user's identification information inputted by the input section and attribution information of information materials used in an event included in the schedule from a predetermined schedule administrating server through the communicating section, and the control section obtains print data of the information materials designated by the attribution information from a predetermined print data administrating server through the communicating section and controls the printing section to print the obtained schedule and the information materials based on the obtained print data.

In the above-mentioned invention, a schedule during a predetermined period of a user (for example, an authenticated user or a login user) corresponding to the inputted user's identification information is obtained from the schedule administrating server, print data of information materials used in an event included in this schedule are obtained from the print data administrating server, and the obtained schedule and the information materials based on the print data are printed and outputted as a set.
[3] The image forming apparatus described in [1] or [2] is characterized in that the image forming apparatus is further equipped with a setup section to receive a setup to set either one of an operation to print automatically the above obtained schedule together with information materials used in an event included the schedule and another operation to ask a user whether or not the information materials are printed at the time of printing the schedule and a setup memorizing section to memorize the content of a setup received by the setup section; and the control section conducts an operation in accordance with the content of a setup memorized in the setup memorizing section at the time of printing the obtained schedule.

In the above-mentioned invention, it is possible to set either one of an operation to print automatically the schedule together with information materials and another operation to ask a user whether or not the information materials are printed together with the schedule as a set at the time of printing the schedule.
[4] The image forming apparatus described in any of [1] to [3] is characterized in that the control section controls the printing section to print a schedule in which an event required to print information materials and an event not required to print information materials are described so enable discrimination between them.

In the above-mentioned invention, a schedule table is printed to describe an event required to print information materials and an event not required to print information materials so as to make it possible to discriminate them by, for example, different colors, different character decorations, different background colors, and different frames.
[5] The image forming apparatus described in any of [1] to [4] is characterized in that the control section controls the printing section to print a schedule table with a different color for each event.
[6] The image forming apparatus described in any of [1] to [5] is characterized in that the control section controls the printing section to print the information materials separately for each event.

In the above-mentioned invention, the information materials are separately printed for each event, for example, by switching over an output tray to receive the delivered information materials for each event or by inserting a cover sheet for each event.
[7] An image forming system is characterized in that the image forming system is equipped an image forming apparatus, a schedule administrating server, and a print data administrating server which are connected to each other to enable communication; the schedule administrating server correlates the time and date of events, the participants of the events and the attribution information of information materials used in the events and memorizes them, the print data administrating server memorizes print data of the information materials and the image forming apparatus is equipped with an input section to input user's identification information, a printing section and a control section; the control section obtains a schedule during a predetermined period of a user corresponding to the user's identification information inputted by the input section and attribution information of information materials used in an event included in the schedule from the schedule administrating server, and the control section obtains print data of the information materials designated by the attribution information from a predetermined print data administrating server and controls the printing section to print the obtained schedule and the information materials based on the obtained print data.

In the above-mentioned invention, the image forming apparatus obtains a schedule during a predetermined period of a user corresponding to the inputted user's identification information from the schedule administrating server, further obtains print data of information materials used in an event included in this schedule from the print data administrating server, and prints and outputs the obtained schedule and the information materials based on the print data as a set.
[8] The image forming system described in [7] is characterized in that the image forming system is further equipped with a setup section to receive a setup to set either one of an operation to print automatically the above obtained schedule together with information materials used in an event included the schedule and another operation to ask a user whether or not the information materials are printed at the time of printing the schedule and a setup memorizing section to memorize the content of a setup received by the setup section; and the control section conducts an operation in accordance with the content of a setup memorized in the setup memorizing section at the time of printing the obtained schedule.
[9] The image forming system described in [7] or [8] is characterized in that the control section controls the printing section to print a schedule in which an event required to print information materials and an event not required to print information materials are described so as to enable discrimination between them.
[10] The image forming apparatus described in any of [7] to [9] is characterized in that the control section controls the printing section to print a schedule table with a different color for each event.
[11] The image forming apparatus described in any of [7] to [10] is characterized in that the control section controls the printing section to print the information materials separately for each event.
[12] The image forming apparatus described in any of [7] to [11] is characterized in that the functions of the schedule administrating server, the print data administrating server, and the image forming apparatus are distributed in arbitral combinations to two or more apparatuses connected to enable communication.

In the above-mentioned invention, the functions of the image forming system are distributed in arbitral combinations to two or more apparatuses connected to enable communication.

According to the image forming apparatus and the image forming system related to the present invention, since information material related to a schedule are printed together with the schedule, each user can be supported so that each user can participate with information materials necessary for events, such as a conference indicated on the schedule.

Moreover, in the case that information materials of plural events are printed, since the information materials are printed separately for each event, the information materials of each even can be discriminated from others.

What is claimed is:

1. An image forming apparatus, comprising:
an input section to input identification information of a user;
a memory section to memorize an event, time and date of the event, participants of the event and print data of information materials used in the event;
a printing section; and
a control section to obtain a schedule of a user corresponding to the identification information inputted by the input section during a predetermined period and print data of information materials used in an event included in the schedule from the memory section, and to control the printing section to print the obtained schedule and the information materials based on the obtained print data.

2. The image forming apparatus described in claim 1, further comprising:
a setting section to receive a setup to designate either one of a first operation to print automatically the obtained schedule together with the information materials used in the event included the schedule and a second operation to ask the user whether or not the information materials are printed at the time of printing the schedule; and
a setup memorizing section to memorize the content of the setup received by the setting section;
wherein the control section conducts one of the first and second operations in accordance with the content of the setup memorized in the setup memorizing section at the time of printing the obtained schedule.

3. The image forming apparatus described in claim 1, wherein the control section controls the printing section to print a schedule in which an event required to print information materials and another event not required to print information materials are described discriminatively from each other.

4. The image forming apparatus described in claim 1, wherein the control section controls the printing section to print a schedule with a different color for each event.

5. The image forming apparatus described in claim 1, wherein the control section controls the printing section to print information materials separately for each event.

6. An image forming apparatus, comprising:
an input section to input identification information of a user;
a communicating section;
a printing section; and
a control section to obtain a schedule of a user corresponding to the identification information inputted by the input section during a predetermined period and attribution information of information materials used in an event included in the schedule from a predetermined schedule administrating server through the communicating section, to further obtain print data of the information materials designated by the obtained attribution information from a predetermined print data administrating server through the communicating section, and to control the printing section to print the obtained schedule and the information materials based on the obtained print data.

7. The image forming apparatus described in claim 6, further comprising:
a setting section to receive a setup to designate either one of a first operation to print automatically the obtained schedule together with the information materials used in the event included the schedule and a second operation to ask the user whether or not the information materials are printed at the time of printing the schedule; and
a setup memorizing section to memorize the content of the setup received by the setting section;
wherein the control section conducts one of the first and second operations in accordance with the content of the setup memorized in the setup memorizing section at the time of printing the obtained schedule.

8. The image forming apparatus described in claim 6, wherein the control section controls the printing section to print a schedule in which an event required to print information materials and another event not required to print information materials are described discriminatively from each other.

9. The image forming apparatus described in claim 6, wherein the control section controls the printing section to print a schedule with a different color for each event.

10. The image forming apparatus described in claim 6, wherein the control section controls the printing section to print information materials separately for each event.

11. An image forming system, comprising:
an image forming apparatus;
a schedule administrating server; and
a print data administrating server; wherein the image forming apparatus, the schedule administrating server and the print data administrating server are connected to each other to enable communication to each other;
wherein the schedule administrating server correlate an event with time and date of the event, participants of the event and attribution information of information materials used in the event, and memorizes the event together with the correlated data of the time and date, the participants and the attribution information of information materials; the print data administrating server memorizes print data of the information materials; and the image forming apparatus comprises an input section to input identification information of a user, a printing section and a control section; and
wherein the control section obtains a schedule of a user corresponding to the identification information inputted by the input section during a predetermined period and attribution information of information materials used in an event included in the schedule from the schedule administrating server, further obtains print data of the information materials designated by the attribution information from the print data administrating server, and controls the printing section to print the obtained schedule and the information materials based on the obtained print data.

12. The image forming system described in claim 11, further comprising:
a setup section to receive a setup to set either one of an operation to print automatically the above obtained schedule together with information materials used in an event included the schedule and another operation to ask a user whether or not the information materials are printed at the time of printing the schedule; and
a setup memorizing section to memorize the content of a setup received by the setup section;
wherein the control section conducts an operation in accordance with the content of a setup memorized in the setup memorizing section at the time of printing the obtained schedule.

13. The image forming apparatus described in claim 11, wherein the control section controls the printing section to print a schedule in which an event required to print information materials and another event not required to print information materials are described discriminatively from each other.

14. The image forming apparatus described in claim 11, wherein the control section controls the printing section to print a schedule with a different color for each event

15. The image forming apparatus described in claim 11, wherein the control section controls the printing section to print information materials separately for each event.

16. The image forming apparatus described in claim 11, wherein the functions of the schedule administrating server, the print data administrating server, and the image forming apparatus are combined into arbitral combinations and distributed to two or more apparatuses connected to enable to conduct communication.
